(19) United States
(12) Patent Application Publication
(10) Pub. No.: US 2010/0238346 A1
(43) Pub. Date: Sep. 23, 2010

(54) COMPACT IMAGING DEVICE

(75) Inventors: Sio Kuan Lam, New Territories (HK); Kwok Sing Cheng, New Territories (HK); Kai Cheong Kwan, Wong Tai Sin (HK)

Correspondence Address: BERKELEY LAW & TECHNOLOGY GROUP, LLP, 17933 NW Evergreen Parkway, Suite 250, BEAVERTON, OR, 97006, US

(73) Assignee: Hong Kong Applied Science and Technology Research Institute Co. Ltd., New Territories (CN)

(21) Appl. No.: 12/405,988

(22) Filed: Mar. 17, 2009

(51) Int. Cl. H04N 5/225

(52) U.S. Cl. 348/374; 348/E05.024

(57) ABSTRACT

The subject matter disclosed herein relates to an imaging device having a small form factor.

### FIELD

The subject matter disclosed herein relates to an imaging device having a small form factor.

### BACKGROUND

Many portable electronic apparatuses, such as a cellular phone and/or a personal digital assistant (PDA) for example, may comprise a compact camera module. Such a module may comprise an image sensor, an imaging lens unit, and/or an actuator to adjust the position of the imaging lens unit with respect to the image sensor. As designers push towards slimmer, smaller, and/or lighter portable electronic apparatuses, compact camera module manufacturers, among others, are facing a challenge of providing smaller compact camera modules that can fit into limited space of the apparatuses.

Length, width, and height of a camera module may comprise three relatively important parameters regarding size reduction considerations. In particular, however, the footprint (length×width) of such a camera module may comprise a more important parameter regarding size reduction considerations: a camera module having a smaller footprint is desirable as it may occupy less area of printed circuit board. This in turn may lead to a higher degree of flexibility of integration as more components may be mounted in a given area of a printed circuit broad. Such increased integration may lead to portable electronic apparatuses able to provide increased functionality, for example.

### BRIEF DESCRIPTION OF THE DRAWINGS

Non-limiting and non-exhaustive embodiments will be described with reference to the following objects, wherein like reference numerals refer to like parts throughout the various objects unless otherwise specified.

FIG. 1 is a view of components that comprise a compact imaging module, according to an embodiment.

FIG. 2 is a side view of a compact imaging module depicting a lens moving in a vertical direction, according to an embodiment.

FIG. 3 is a side view of a compact imaging module depicting a lens moving in a horizontal direction, according to an embodiment.

FIG. 4 is a side view of a compact imaging module depicting a lens rotating about a horizontal axis, according to an embodiment.

FIG. 5 is a side view of a compact imaging module depicting a lens rotating about a vertical axis, according to an embodiment.

FIG. 6 is a schematic view of a piezoelectric element, according to an embodiment.

FIG. 7 is a schematic view of a bi-laminar piezoelectric element, according to an embodiment.

FIG. 8 is a side view of a compact imaging module, according to an embodiment.

FIG. 9 is a side view of a compact imaging module, according to another embodiment.

### SUMMARY

In one particular implementation, an apparatus may comprise at least one electro-active device to adjust a position of a lens unit, and an image sensor, wherein the electro-active device may be mounted on the image sensor. Such a lens unit may be mounted on the electro-active device. It should be understood, however, that this is merely an example implementation and that claimed subject matter is not limited to this particular implementation.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

Likewise, the terms, “and,” “and/or,” and “or” as used herein may include a variety of meanings that also is expected to depend at least in part upon the context in which such terms are used. Typically, “or” as well as “and/or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures, or characteristics. Though, it should be noted that this is merely an illustrative example and claimed subject matter is not limited to this example.

A camera module design and related manufacturing technology proposed in U.S. Patent Application No. 20050248680 are directed to reducing the size of a miniature camera module. As described in the application, a camera module may be formed by mounting an imaging lens unit on top of an image sensor directly. The imaging lens unit may be formed by stacking individual lenses on top of each other. By this design, footprints of a camera module approach a lower limitation; the area of image sensor. However, a key limitation associated with this design is that the position of the imaging lens unit is fixed on the image sensor surface. Accordingly, such a module is therefore not able to perform a focusing function for objects at various distances, since a focusing function involves altering a distance between an imaging lens and an image sensor. As a result, quality of a captured image may be degraded. In contrast, embodiments described herein include a compact module design that provides a mechanism or allows a process to adjust the distance between an imaging lens and an image sensor, wherein a footprint of the compact module is substantially the same as a footprint of the image sensor, for example.

In an embodiment, a structure of a compact imaging module, such as a compact camera module for example, may provide auto-focus, image stabilization, and/or other advance imaging functions, in which at least one electro-active device is mounted onto an image sensor. In one implementation, such a configuration may comprise an intervening spacer disposed between an electro-active device and an image sensor. In another implementation, a structure or material layer may be disposed between an electro-active device and an image sensor so that the electro-active device is indirectly mounted on the image sensor. Such a structure and/or material layer may comprise a functionality regarding electronic and/or mechanical properties of the compact imaging module, for example.

An imaging apparatus may comprise a lens unit, at least one electro-active device to adjust the position of the lens unit, and an image sensor, wherein the electro-active device may be mounted on the image sensor and the lens unit may be mounted on the electro-active device. The electro-active device may drive such a lens unit in a particular mode of motion, such as translation, rotation, and/or a tilting motion, with respect to the image sensor. Such an electo-active device may provide a relatively precise control of motion of a lens unit, so that various imaging functions, such as focusing for example, may lead to an improved image quality. An advantage of such a compact module is that its footprint may be substantially equal to or smaller than a footprint of an image sensor. Moreover, a batch manufacturing process may be applied to such a compact module that includes a properly designed electro-active device. Such a batch process may occur on a wafer level process, for example. Such a process may lead to a relatively high manufacturing efficiency, thus lowering manufacturing costs of a camera, for example, due to a focus variation function provided by the compact module. In an embodiment, a compact imaging module may comprise an image sensor, a lens unit, and/or an electro-active device to adjust the position of the lens unit with respect to the image sensor, wherein the electro-active device may be mounted on the image sensor and the lens unit may be mounted on the electro-active device. For example, an electro-active device may be mounted on an inactive region of an image sensor. Such a configuration may allow an electro-active device to have a cross-section that is substantially the same size or smaller than an image sensor. An electro-active device may comprise one or more actuators, such as an electromagnetic actuator including an electric coil at least partially surrounded by a yoke having one or more permanent magnets, for example. Another type of electro-active device may include a piezoelectric actuator, wherein a voltage may be applied to change a physical dimension of the actuator. Such electro-active devices may be adapted to adjust a position of a lens vertically, horizontally, rotationally about a substantially horizontal axis, and/or rotationally about a substantially vertical axis, for example. As used herein, “vertically” refers to a direction substantially parallel to an optical axis of a compact camera module, whereas “horizontally” refers to a direction substantially perpendicular to an optical axis of a compact camera module.

In another embodiment, a compact imaging module may comprise an image sensor, a lens unit, an electro-active device to adjust the position of the lens unit with respect to the image sensor, and a surface or platform, such as a printed circuit board (PCB) to which the image sensor may be mounted, for example. The electro-active device may be mounted on an image sensor in such a way that the image sensor provides a physical separation between the electro-active device and the PCB. For example, an electro-active device may be mounted on an inactive region of an image sensor so that the electro-active device does not physically contact a PCB on which the image sensor is disposed. Such a mounting configuration may allow an electro-active device to have a cross-section that is substantially the same size or smaller than an image sensor. Of course, such a configuration is merely an example, and claimed subject matter is not so limited.

In another embodiment, a compact imaging module may comprise an image sensor and an actuator to adjust a position of one or more lens units with respect to the image sensor. If the actuator is mounted to the image sensor, such a pre-assembled compact imaging module may be adapted to mount on a printed circuit board (PCB) in a subsequent manufacturing process, for example. In one particular embodiment, such a manufacturing process may include a wafer-level process, wherein components such as an image sensor, actuator, and/or lens may be formed together as a module in a wafer-level process. Of course, such a process is merely an example, and claimed subject matter is not so limited.

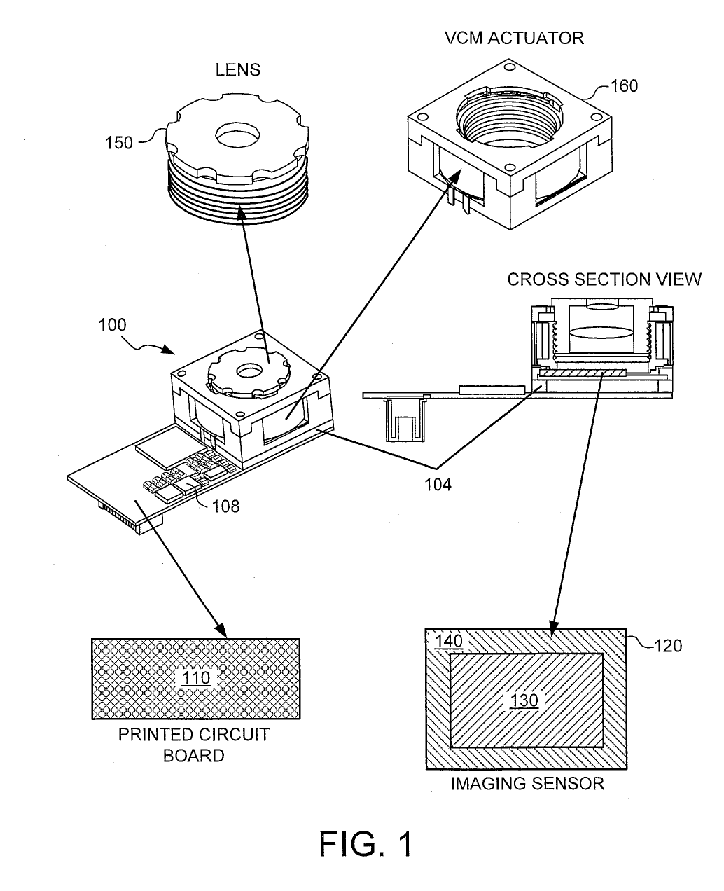

FIG. 1 is a view of a compact imaging module 100, according to an embodiment. Such an imaging module may comprise an image sensor 120 mounted on a PCB 110. Of course, as described above, an imaging module need not include a PCB, which may instead only be combined with the imaging module in a subsequent process. Image sensor 120 may comprise an active region 130 including an array of pixilated charge-coupled devices (CCD) or one or more complementary metal-oxide-semiconductor (CMOS) devices. Inactive region 140 of image sensor 120 may comprise a border to provide physical support to active region 130. During operation, active region 130 may reach relatively high temperatures, so that inactive region 140 may also provide heat sinking to active region 130, particularly if inactive region 140 comprises a thermally conductive material, such as a metal for example. Imaging module 100 may further comprise a lens assembly, which may include one or more lens units to provide an image onto active region 130 of image sensor 120. Such an image need not comprise visible wavelengths, but may also comprise infrared and/or ultraviolet wavelengths, for example. So that such an image is focused onto active region 130, actuator 160 may adjust a position of lens assembly 150 with respect to the image sensor. In a particular implementation, imaging module 100 may further comprise a spacer 104 disposed between actuator 160 and PCB 110 as well as electronics 108, for example.

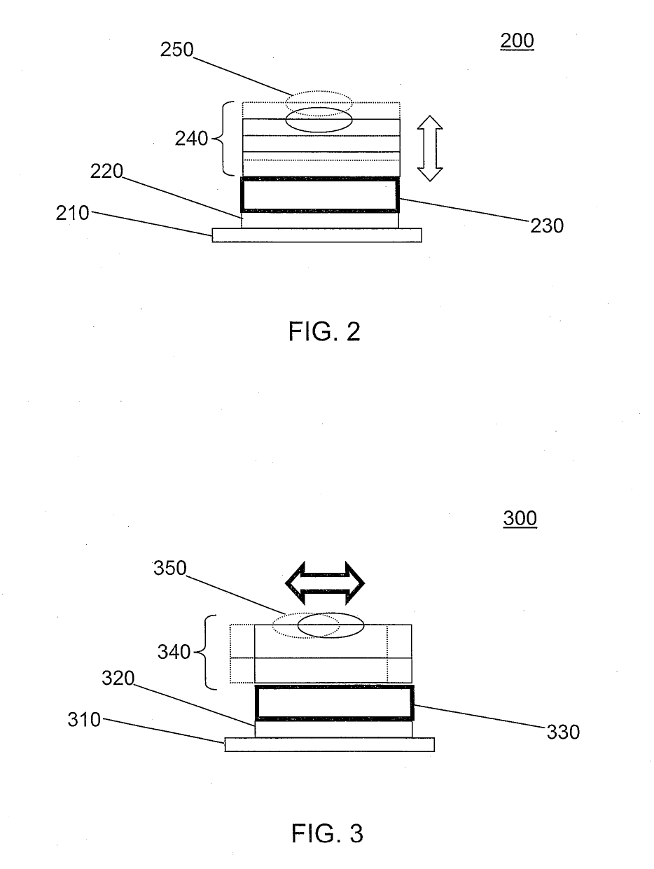

FIG. 2 is a side view of a compact imaging module 200 comprising an electro-active device 230 disposed on an image sensor 220, which may be electrically and/or physically mounted on a PCB 210. In an embodiment, as mentioned above, electro-active device 230 may be disposed on image sensor 220 in such a way as to provide a physical separation between electro-active device 230 and PCB 210. For example, electro-active device 230 may be mounted on an inactive region of image sensor 220 so that electro-active device 230 does not physically contact PCB 210 (on which the image sensor is disposed). Accordingly, such an electro-active device may have a smaller cross-section and/or profile compared to an electro-active device that is wide enough to extend beyond an image sensor perimeter to reach (and mount to) a PCB. In other words, in the latter case, the wider electro-active device may be physically mountable to a PCB, but such a wider electro-active device may involve an electro-active device that is wider than an image sensor that is disposed between the electro-active device and the PCB. Thus, an electro-active device that mounts to an image sensor may provide an opportunity to reduce a size and/or volume of an imaging module, such as compact imaging module 200. In addition, according to a particular embodiment, a PCB need not provide an electro-active device with electrical signals, so that an electro-active device need not be electrically contacting a PCB. For example, electrical signals may be provided to an electro-active device via electrical connectors from sources other than a PCB. Accordingly, compact imaging module 200 provides a smaller profile size since electro-active device 230 is mounted to image sensor 220 instead of PCB 210. To describe compact imaging module 200 in another way, a top-view surface area of electro-active device 230 may be equal to or less than that of image sensor 220, thus maintaining a relatively small area and volume.

In an embodiment, electro-active device 230 may be adapted to adjust a vertical position of at least a portion of lens assembly 240 with respect to image sensor 220. Such a lens assembly may comprise one or more lens units 250 so that the vertical position of one or more of such lenses may be adjusted. Electro-active device 230 may comprise an electromagnetic actuator or a piezoelectric actuator, as indicated above. For example, an electromagnetic actuator may include an electric coil which may be partially surrounded by a yoke having one or more permanent magnets. For another example, a piezoelectric actuator may employ one or more piezoelectric elements, which may comprise a piezoelectric ceramic and/or a crystal material. Such an electro-active device may provide a means for such a vertical adjustment, as explained below.

FIG. 3 is a side view of a compact imaging module 300 comprising an electro-active device 330 disposed on an image sensor 320, which may be electrically and/or physically mounted on a PCB 310. In an embodiment, similar to that shown in FIG. 2, electro-active device 330 may be disposed on image sensor 320 in such a way as to provide a physical separation between electro-active device 330 and PCB 310. Electro-active device 330 may be adapted to adjust a horizontal position of at least a portion of lens assembly 340 with respect to image sensor 320. Such a lens assembly may comprise one or more lens units 350 so that the horizontal position of one or more of such lenses may be adjusted. As described above, electro-active device 330 may be an electromagnetic actuator or a piezoelectric actuator. An electro-active device employing one or more bi-laminar piezoelectric elements, which are described in detail below, may provide means for such a horizontal adjustment. In a particular embodiment, such an adjustment may be useful to position a lens for image stabilization, such as for an anti-shaking function, for example, though claimed subject matter is not so limited.

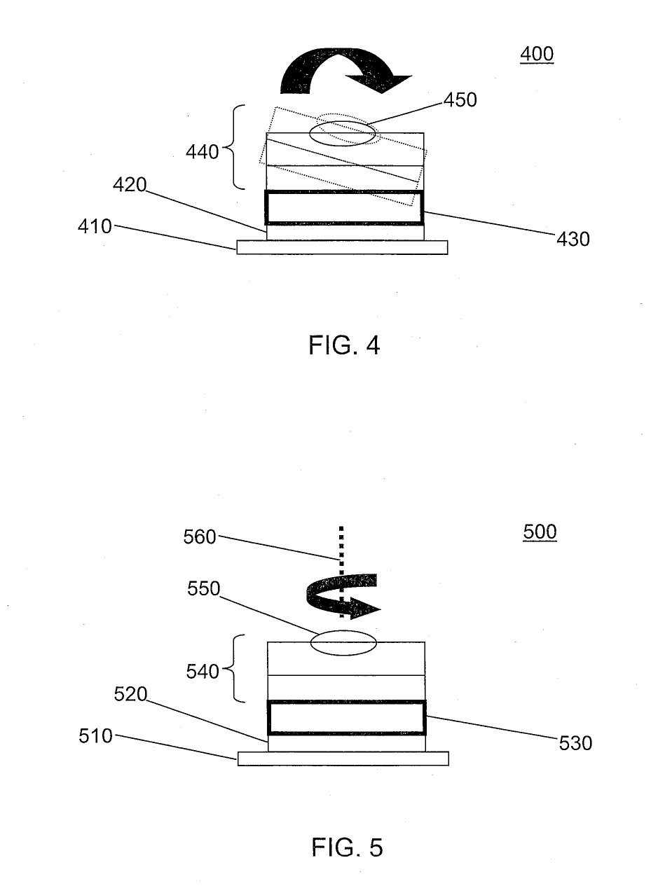

FIG. 4 is a side view of a compact imaging module 400 comprising an electro-active device 430 disposed on an image sensor 420, which may be electrically and/or physically mounted on a PCB 410. In an embodiment, similar to that shown in FIG. 2, electro-active device 430 may be disposed on image sensor 420 in such a way as to provide a physical separation between electro-active device 430 and PCB 410. Electro-active device 430 may be adapted to rotationally adjust a position of at least a portion of lens assembly 440 with respect to image sensor 420. Such rotational adjustment may be about a substantially horizontal axis (not shown, but would be coming out of the page of FIG. 4). Lens assembly 440 may comprise one or more lens units 450 so that the position of one or more of such lenses may be adjusted. As described above, electro-active device 430 may be an electromagnetic actuator or a piezoelectric actuator. An electro-active device employing one or more piezoelectric elements may provide means for such a rotational adjustment, as described in detail below. In a particular embodiment, such an adjustment may be useful to provide an advance asymmetric imaging function, for example, though claimed subject matter is not so limited.

FIG. 5 is a side view of a compact imaging module 500 comprising an electro-active device 530 disposed on an image sensor 520, which may be electrically and/or physically mounted on a PCB 510. In an embodiment, similar to that shown in FIG. 4, electro-active device 530 may be disposed on image sensor 520 in such a way as to provide a physical separation between electro-active device 530 and PCB 510. Electro-active device 530 may be adapted to rotationally adjust a position of at least a portion of lens assembly 540 with respect to image sensor 520. Such rotational adjustment may include a rotation of such a portion of lens assembly 540 about a substantially vertical axis 560. Lens assembly 540 may comprise one or more lens units 550 so that the position of one or more of such lenses may be adjusted. As used herein, vertical refers to a direction parallel to an optical axis of lens assembly 540 and/or an optical axis of imaging module 500. Electro-active device 530, which may comprise an electromagnetic actuator or a piezoelectric actuator, described in detail below, may provide means for such a rotational adjustment.

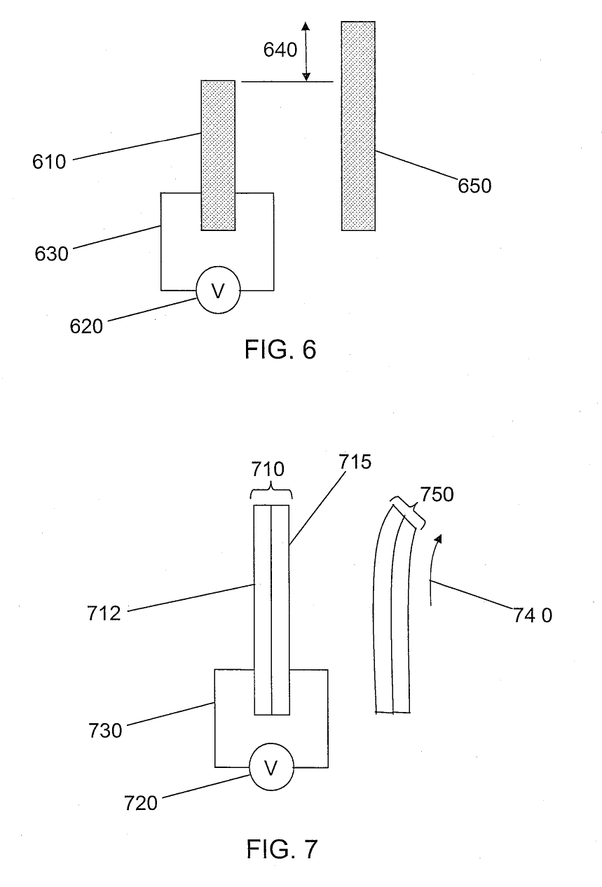

FIG. 6 is a schematic view of a piezoelectric element 610, according to an embodiment. A voltage 620 applied to electrical terminals 630 may induce a size change 640 along a particular direction, as shown in FIG. 6 for example. Accordingly, piezoelectric element 610 may attain a new size, as represented by piezoelectric element 650. If a lens assembly, for example, is fixed to such a piezoelectric element, then a position and/or orientation of the lens assembly may change as the size of the piezoelectric element changes. Accordingly, a process for adjusting a position of a lens may include applying voltage 620 to electrical terminals 630 to change the size of piezoelectric element 610 along a particular direction. Of course, such a process to change a position of a lens is merely an example, and claimed subject matter is not so limited.

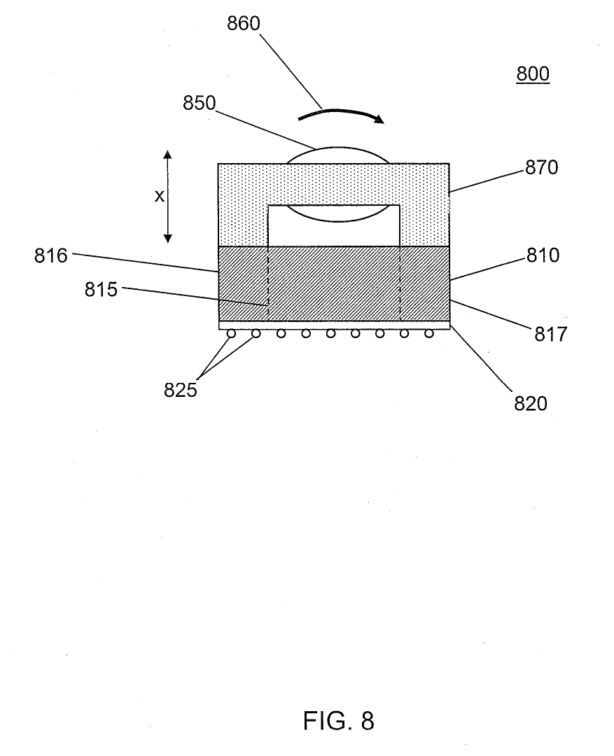

FIG. 7 is a schematic view of a bi-laminar piezoelectric element 710, according to an embodiment. piezoelectric element 710 may comprise multiple piezoelectric elements laminated to one another, such as a first piezoelectric element 712 and a second piezoelectric element 715. In a particular embodiment, one piezoelectric element may expand more than another piezoelectric element so that a voltage applied to the first and second piezoelectric elements may lead to differential expansion, wherein one piezoelectric element expands at a different rate than another piezoelectric element. For example, a voltage 720 applied to electrical terminals 730 may induce a greater size change in first piezoelectric element 712 than a size change in second piezoelectric element 715 resulting from application of the same voltage. Such a differential expansion may provide non-uniform shear forces across a cross-section of bi-laminar piezoelectric element 750, which may provide bending as a result. Accordingly, piezoelectric element 710 may attain a new size and/or shape, as represented by a curvature 740 of bi-laminar piezoelectric element 750, as shown in FIG. 7. For example, bi-laminar piezoelectric element 750 is curved with respect to bi-laminar piezoelectric element 710 as a result of applying voltage 720 to bi-laminar piezoelectric element 750. If a lens assembly, for example, is fixed to such a bi-laminar piezoelectric element, then the position and/or orientation of the lens assembly may change as the size of the bi-laminar piezoelectric element changes from application of voltage thereon. Accordingly, a process for adjusting a position of a lens may include applying voltage 720 to electrical terminals 730 to change the size and/or shape of bi-laminar piezoelectric element 710. Of course, such a process to change a position of a lens is merely an example, and claimed subject matter is not so limited.

FIG. 8 is a side view of a compact imaging module 800, according to an embodiment. Such a module may comprise an electro-active device 810 that physically supports a lens assembly 870 including one or more lens units 850. Electro-active device 810, which may comprise an electromagnetic actuator or a piezoelectric actuator, may be mounted on an image sensor 820 having electrical connections 825 for mounting to a PCB (not shown). For example, an electromagnetic actuator may include an electric coil which could be partially surrounded by a yoke having one or more permanent magnets. For another example, piezoelectric actuator may include one or more piezoelectric elements and/or one or more bi-laminar piezoelectric elements. A cavity 815 may provide a path for imaging light rays from one or more lens units 850 to reach image sensor 820. As explained above, a voltage may be applied to one or more piezoelectric elements of piezoelectric actuator 810 to change a size of the piezoelectric actuator along a particular side and/or direction, such as the x-axis shown in FIG. 8 for example. For example, a voltage applied in a y-direction of a piezoelectric may provide an expansion of the piezoelectric in an x-direction, though claimed subject matter is not so limited. Accordingly, as piezoelectric actuator 810 changes size along the x-axis, a vertical position of lens assembly 870 may also change. In this fashion, a vertical position of one or more lens units 850 may be changed to adjust a position of a focal plane of one or more lens units 850 to coincide with an active region surface of image sensor 820. In another example, as the left side 816 of piezoelectric actuator 810 changes size along the x-axis while the size of the right side 817 remains unchanged (or if the right side 817 expands at a lesser rate than that of the left side 816), lens assembly 870 may rotate about a substantially horizontal axis, as indicated by arrow 860. In this fashion, a position of one or more lens units 850 may be changed with respect to an active region surface of image sensor 820.

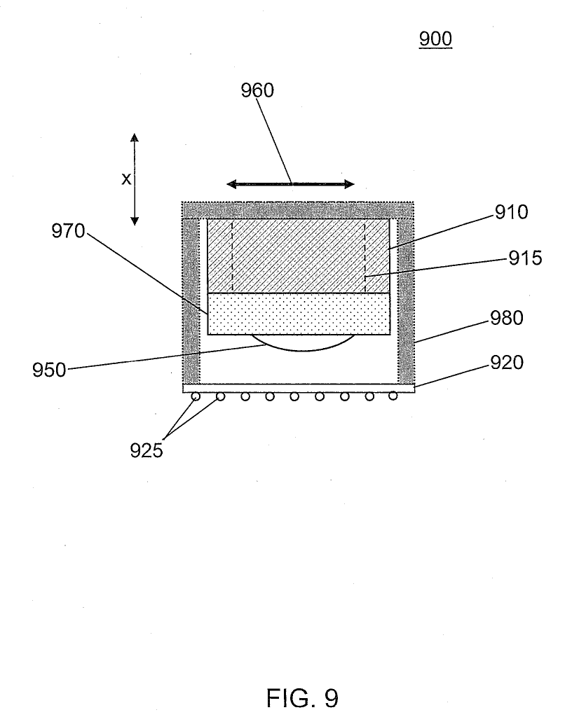

FIG. 9 is a side view of a compact imaging module, according to another embodiment. Such a module may comprise an electro-active device 910 that may include one or more piezoelectric elements and/or one or more bi-laminar piezoelectric elements. Piezoelectric electro-active device 910 may physically support a lens assembly 970 including one or more lens units 950. Electro-active device 910 may comprise an electromagnetic actuator or a piezoelectric actuator. For example, an electromagnetic actuator may include an electric coil which may be partially surrounded by a yoke having one or more permanent magnets. For another example, piezoelectric actuator may include one or more piezoelectric elements and/or one or more bi-laminar piezoelectric elements. Electro-active device 910 may be supported by a supporting structure 980, which may be mounted on a portion of an image sensor 920, such as an inactive region of image sensor 920, for example. In a particular embodiment, supporting structure 980 may comprise a thermally conducting material to provide heat-sinking to image sensor 920. Image sensor 920 may include electrical connections 925 for mounting to a PCB (not shown). A cavity 915 may provide a path for imaging light rays from one or more lens units 950 to reach image sensor 920. As explained above, a voltage may be applied to one or more piezoelectric elements of piezoelectric actuator 910 to change a size of the piezoelectric actuator along a particular direction, such as the x-axis shown in FIG. 9 for example. Accordingly, as piezoelectric actuator 910 changes size along the x-axis, a vertical position of lens assembly 970 may also change. In this fashion, a vertical position of one or more lens units 950 may be changed to adjust a position of a focal plane of one or more lens units 950 to coincide with an active region surface of image sensor 920. In another example, piezoelectric actuator 910 may comprise bi-laminar piezoelectric element so that a voltage applied to piezoelectric actuator 910 may lead to a sideway shift of lens assembly 970, as indicated by arrow 960 in FIG. 9. In this fashion, a position of one or more lens units 950 may be changed with respect to an active region surface of image sensor 920.

One skilled in the art will realize that a virtually unlimited number of variations to the above descriptions is possible, and that the examples and the accompanying figures are merely to illustrate one or more particular implementations.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. An apparatus comprising:
at least one electro-active device to adjust a position of a lens unit; and
an image sensor, wherein said electro-active device is mounted on said image sensor.

2. The apparatus of claim 1, wherein said lens unit is mounted on said electro-active device.

3. The apparatus of claim 1, wherein said electro-active device is indirectly mounted on said image sensor.

4. The apparatus of claim 1, further comprising a platform, wherein said image sensor provides a physical separation between said electro-active device and said platform.

5. The apparatus of claim 4, where said platform comprises a printed circuit board (PCB).

6. The apparatus of claim 1, wherein said electro-active device comprises at least one actuator adapted to adjust said position of said lens unit in one or more directions.

7. The apparatus of claim 1, wherein said electro-active device comprises at least one actuator adapted to adjust said position of said lens unit vertically and/or rotationally about a substantially horizontal axis.

8. The apparatus of claim 1, wherein said electro-active device comprises at least one actuator adapted to adjust said position of said lens unit vertically and/or rotationally about a substantially vertical axis.

9. The apparatus of claim 1, wherein said electro-active device comprises an electro-magnetic actuator.

10. The apparatus of claim 1, wherein said electro-active device comprises a piezoelectric actuator.

11. The apparatus of claim 1, wherein said image sensor comprises a pixilated charge-coupled device (CCD) or a complementary metal-oxide-semiconductor (CMOS) device.

12. The apparatus of claim 1, wherein said electro-active device comprises a supporting element to provide a physical separation between said image sensor and said electro-active device, and wherein said supporting element is mounted on said image sensor.

13. The apparatus of claim 12, wherein said supporting element comprises a spacer or a layer to provide an electrical connection between said electro-active device and said image sensor.

14. The apparatus of claim 1, wherein a top-view surface area of said electro-active device is substantially equal to that of said image sensor.

15. A method comprising:
mounting at least one electro-active device on an image sensor to provide an imaging device adapted to mount on a printed circuit board (PCB).

16. The method of claim 15, further comprising mounting said lens unit on said electro-active device.

17. The method of claim 15, further comprising:
mounting said imaging device on said PCB; and
providing a physical separation between said electro-active device and said PCB.

18. The method of claim 15, wherein said electro-active device comprises an actuator adapted to adjust said position of a lens unit in one or more directions.

19. The method of claim 15, wherein said electro-active device comprises an actuator adapted to adjust said position of a lens unit vertically and/or rotationally about a substantially horizontal axis.

20. The method of claim 15, wherein said electro-active device comprises an actuator adapted to adjust said position of a lens unit vertically and/or rotationally about a substantially vertical axis.

21. The method of claim 15, wherein said electro-active device comprises an electro-magnetic actuator.

22. The method of claim 15, wherein said electro-active device comprises a piezoelectric actuator.

23. The method of claim 15, wherein said image sensor comprises a pixilated charge-coupled device (CCD) or a complementary metal-oxide-semiconductor (CMOS) device.

24. The method of claim 15, wherein a top-view surface area of said electro-active device is substantially equal to that of said image sensor.

25. An apparatus comprising:
means for mounting at least one electro-active device on an image sensor to provide an imaging device adapted to mount on a printed circuit board (PCB).

26. The apparatus of claim 25, further comprising:
means for mounting said imaging device on said PCB; and
means for providing a physical separation between said electro-active device and said PCB.

27. The apparatus of claim 25, wherein said electro-active device comprises an actuator adapted to adjust said position of a lens unit in one or more directions.

28. The apparatus of claim 25, wherein said electro-active device comprises an actuator adapted to adjust said position of a lens unit vertically and/or rotationally about a substantially horizontal axis.

29. The apparatus of claim 25, wherein said electro-active device comprises an actuator electro-active device adapted to adjust said position of a lens unit vertically and/or rotationally about a substantially vertical axis.

30. The apparatus of claim 25, wherein said electro-active device comprises an electro-magnetic actuator.

31. The apparatus of claim 25, wherein said electro-active device comprises a piezoelectric actuator.

32. The apparatus of claim 25, wherein said image sensor comprises a pixilated charge-coupled device (CCD) or a complementary metal-oxide-semiconductor (CMOS) device.

33. The apparatus of claim 25, wherein a top-view surface area of said electro-active device is substantially equal to that of said image sensor.

34. An apparatus comprising:
means for mounting a lens units on at least one electro-active device; and
means for mounting said electro-active device on an image sensor to provide an imaging device.

35. The apparatus of claim 34, further comprising:
means for mounting said imaging device on a printed circuit board (PCB); and
means for providing a physical separation between said electro-active device and said PCB.

36. The apparatus of claim 34, wherein said electro-active device comprises at least one actuator adapted to adjust the position of said lens unit in one or more directions.
